(19) United States
(12) Patent Application Publication
(10) Pub. No.: US 2026/0275196 A1
(43) Pub. Date: Sep. 17, 2026

(54) LIQUID CRYSTAL ELASTOMERS VIA THIOL-ENE PHOTOPOLYMERIZATION

(71) Applicant: The Regents of the University of Colorado, a body corporate, Denver, CO (US)

(72) Inventors: Timothy WHITE, Longmont, CO (US); Hayden FOWLER, Albuquerque, NM (US); Alexis PHILLIPS, Boulder, CO (US); Kristin LEWIS, Ada, MI (US)

(21) Appl. No.: 19/267,245

(22) Filed: Jul. 11, 2025

Related U.S. Application Data
(60) Provisional application No. 63/770,156, filed on Mar. 11, 2025.

(51) Int. Cl. C09K 19/38; C09J 4/00

(52) U.S. Cl. CPC C09K 19/38; C09J 4/00; C09J 2400/20

(57) ABSTRACT

A process for forming of LCEs via a one-step thiol-ene photopolymerization. The thiolene photopolymerization reaction utilizes an ene monomer (e.g., a liquid crystal ene or diene), a thiol monomer (e.g., a non-liquid crystalline thiol or a liquid crystalline thiol), and a thiol crosslinker, with an initiator such as a photoinitiator. In some embodiments, an alignable liquid crystal elastomer is formed from nothing more than liquid crystal ene monomer(s), liquid crystalline or non-liquid crystalline thiol monomer(s), a thiol crosslinker and an initiator. This reaction is amenable to surface-enforced alignment, which enables high-fidelity inscription of complex director profiles. The LCE composition can be directly tailored by the concentration of a multifunctional thiol crosslinker.

### CROSS-REFERENCE

This application claims priority to U.S. provisional application 63/770,156 filed Mar. 11, 2025, the entire disclosures of which is incorporated herein by reference for all purposes.

### GOVERNMENT FUNDING

This invention was made with government support under Grant Number DMR2105369 awarded by the National Science Foundation, and Grant Number N00014-22-1-2361 awarded by the U.S. Department of Defense. The government has certain rights in the invention.

### BACKGROUND

Liquid crystal elastomers (LCEs) assimilate the anisotropy of liquid crystalline phases with the rubber elasticity of polymer networks. LCEs have been prepared by sequential chain extension reactions of diacrylate liquid crystalline monomers followed by photopolymerization of liquid crystalline oligomers. While these reactions are widely utilized, sample preparation can occur for hours or days. LCEs have also been prepared via direct thiol-acrylate photopolymerization via free radical chain transfer reactions. While this is a quick and direct means of preparing LCEs, the topology of the polymer network composition is heterogeneous, with wide variance in molecular weight between crosslinks and extensive pendant groups.

### SUMMARY

The present disclosure describes a process for forming of LCEs via a one-step thiol-ene photopolymerization. This reaction is amenable to surface-enforced alignment, which enables high-fidelity inscription of complex director profiles. The LCE composition can be directly tailored by the concentration of the multifunctional crosslinking monomer (e.g., a tetrathiol).

In particular, the thiol-ene photopolymerization reaction utilizes a liquid crystal ene, which can include a diene, and a thiol (e.g., a non-liquid crystalline thiol or a liquid crystalline thiol), optionally with an initiator such as a photoinitiator. In some embodiments, the alignable liquid crystal elastomer is formed from nothing more than liquid crystal diene monomer(s), non-liquid crystalline thiol monomer(s), and an initiator such as a photoinitiator. In some other embodiments, the alignable liquid crystal elastomer is formed from nothing more than liquid crystal ene monomer(s), liquid crystalline thiol monomer(s), and an initiator such as a photoinitiator; in some of these embodiments, a radical inhibitor may be included.

Described herein are various embodiments of alignable liquid crystal elastomers (LCEs) and methods of making the same. The one-step thiol-ene photopolymerization process enables scalable and surface-aligned LCEs with tunable thermomechanical response through precise control over crosslink density. The processes utilize step-growth radical polymerization that can be used with both liquid crystalline and non-liquid crystalline thiol systems. The crosslinking can be tailored via the ene monomer and thiol ratios. The resulting LCEs can be directly photoaligned via monomeric melts.

The LCEs described herein are formed from a first monomer having an ene (e.g., diene) functionality and a second monomer having a thiol functionality. In some embodiments, the first monomer is a liquid crystal diene monomer and the second monomer is a non-liquid crystalline thiol monomer. In some other embodiments, the first monomer is a liquid crystal ene monomer and the second monomer is a liquid crystalline thiol monomer, e.g., used to enhance molecular ordering. The stoichiometric ratio of the ene:thiol functional groups is at or near 1:1. The degree of cross-linking has an impact on the resulting material properties of the LCE, particularly the thermomechanical performance.

By utilizing a chemistry which proceeds primarily through step growth, the network formation and resulting LCE properties can be more precisely controlled as the cross-linking mostly occurs through the introduction of multifunctional molecules, rather than solely through homopolymerization. The LCEs are subject to alignment by surface anchoring, which has previously proven difficult for LCEs produced with thiol-ene photopolymerization.

Embodiments described herein include methods for forming the LCEs by photopolymerizing the first monomer and the second monomer, wherein the first monomer and the second monomer are similar or identical to the first monomer and second monomer described previously.

These and other aspects of the synthesis methods and doped materials described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE FIGURES

FIG. 1A shows molecular structures of an alkene-functionalized liquid crystalline monomer (LC2E, also referred to as C6E-Me), thiol-functionalized monomers (PETMP, EDDET, and GDMP), an inhibitor (BHT), and an initiator (I-369); FIG. 1B is a schematic rendering of a thiol-ene photopolymerization.

FIG. 2A and FIG. 2B are graphical representations of alkene (FIG. 2A) and thiol (FIG. 2B) functional group conversion during the initial 5 seconds of photopolymerization for LCE compositions prepared with three compositions; FIG. 2C is a graphical representation of overall functional group conversion to the calculated gel point conversion as a function of mol % of crosslinker.

FIGS. 3A and 3B are graphical representations of thiol (FIG. 3A) and alkene (FIG. 3B) functional group conversion, determined by RTIR, for the first minute of photopolymerization for LCE compositions prepared with three compositions.

FIG. 4A is a polarized micrograph of an LCE prepared with 14 mol % PETMP with a 10× objective; FIG. 4B X-ray scattering pattern at wide angles illustrating the classic nematic eyebrow pattern indicative of uniaxial alignment; FIG. 4C is a polarized micrograph with a 20× objective illustrating the microstructure normal to the alignment direction; FIG. 4D shows the X-ray scattering pattern at small angles confirming the cybotactic nematic phase consisting of smectic C domains within an overall nematic matrix.

FIG. 5A is a photomicrograph of an LCE prepared with 21 mol % PETMP, showing birefringence with POM, using a 10× objective; FIG. 5B is a photomicrograph of an LCE prepared with 29 mol % PETMP, showing birefringence with POM, using a 10× objective.

FIG. 6A shows results from X-ray scattering (WAXS) for an LCE prepared with 21 mol % PETMP, showing a classical eyebrow scattering pattern for aligned LCEs; FIG. 6B shows results from X-ray scattering (WAXS) for an LCE prepared with 29 mol % PETMP, showing a classical eyebrow scattering pattern for aligned LCEs.

FIG. 7A is a micrograph from POM of an LCE prepared with 21 mol % PETMP, showing striation texture opposite of the alignment direction using a 20× objective; FIG. 7B is a micrograph from POM of an LCE prepared with 29 mol % PETMP, showing striation texture opposite of the alignment direction using a 20× objective.

FIG. 8A is a micrograph from SAXS of an LCE prepared with 21 mol % PETMP, showing scattering patterns indicating cybotactic nematic phase behavior; FIG. 8B is a micrograph from SAXS of an LCE prepared with 29 mol % PETMP, showing scattering patterns indicating cybotactic nematic phase behavior; FIG. 8C is a graphical representation of azimuthal intensity profiles for three LCEs.

FIG. 9A is a graphical representation of DSC thermograms of three LCEs; FIG. 9B is a graphical representation of the glass transition temperature for the three LCEs; FIG. 9C is a graphical representation of nematic-isotropic transition temperature as a function of crosslinker concentration for the three LCEs.

FIG. 10A is a graphical representation of tensile curves parallel to the direction of alignment for three uniaxially-aligned LCEs; FIG. 10B is a graphical representation of tensile curves perpendicular to the direction of alignment for the three uniaxially-aligned LCEs; FIG. 10C is a graphical representation of Young's modulus for deformation parallel and perpendicular to the nematic director as a function of crosslinker concentration; FIG. 10D is a graphical representation of modulus contrast (Y_{∥}/Y_{⊥}) of the three LCEs as a function of crosslinker concentration.

FIGS. 11A and 11B are graphical representations of the thermomechanical contractile strain response as a function of temperature (FIG. 11A) and corresponding derivative for LCEs (FIG. 111B) prepared with 14 mol % PETMP (solid line), 21 mol % PETMP (large dashed line), and 29 mol % PETMP (small dashed line).

FIG. 12A is photomicrographs from POM as a function of temperature; FIG. 12B is photomicrographs from WAXS as a function of temperature; FIG. 12C is photomicrographs from SAXS as a function of temperature; FIG. 12D is a graphical representation of WAXS intensity profiles as a function of azimuthal angle; FIG. 12E is a graphical representation of SAXS intensity profiles as a function of azimuthal angle.

FIG. 13A is a graphical representation of the overall functional groups conversion as a function of crosslinker:thiol monomer.

FIG. 13B is a graphical representation of gel fraction as a function of crosslinker:thiol monomer.

FIG. 13C is a graphical representation of DSC thermograms of the LCE films as a function of the molar ratio of crosslinker to thiol monomer.

### DETAILED DESCRIPTION

Liquid crystal elastomers (LCEs) are soft, stimuli-responsive materials in which liquid crystalline mesogenic units are incorporated into a lightly crosslinked polymer network. Prior research of LCEs has considered the functional utility of their nonlinear deformation as well as their stimuli-response (e.g., actuation). Here, the nascent thermotropism of LCEs (e.g., heating LCEs reduces the extent of liquid crystallinity to near zero) is evaluated. While LCEs that retain the polydomain orientation exhibit thermomechanical responses, the deformation is uniform in all axes. However, when LCEs are aligned, the directional deformation of the materials can achieve as much as 50% contractile strain upon heating, and more.

Historically, LCEs have been prepared by two-step hydrosilylation reactions with alignment imparted by mechanical force in the second polymerization stage. More recently, LCEs have been prepared via a two-step process in which diacrylate liquid crystalline monomers (LCMs) were subjected to a thiol-Michael addition reaction followed by subsequent photopolymerization of excess acrylate bonds to arrest the LCE in a mechanically deformed state (e.g., aligned). LCEs prepared by thiol-Michael addition have displaced hydrosilylation reactions due to the ease and accessibility of this chemistry. Further, the rheological properties make this chemistry conducive to printing via direct ink writing, which has been utilized to produce LCEs with spatial variation in alignment.

While mechanical and rheological methods are widely utilized to prepare aligned LCEs, these methods are limited in scalability (mechanical alignment) or patterning fidelity (rheological alignment). Other approaches have been utilized to enforce alignment to LCEs, including magnetic and electric fields as well as surface anchoring. Surface anchoring is widely utilized in the large-scale manufacture of liquid crystal displays and optical films from LCMs. Glassy liquid crystalline polymer networks (LCNs) have also been prepared via surface-enforced alignment, e.g., by photopolymerizing diacrylate liquid crystalline oligomers prepared by an aza-Michael addition reaction.

Other materials chemistries have been subsequently demonstrated to be amenable to surface anchoring, generally utilizing thiol-acrylate reactions. In one approach, referred to as free-radical chain transfer, LCEs are prepared from formulations containing diacrylate LCMs and dithiol monomers that act as both chain extenders as well as chain transfer agents. This chemistry is robust, strongly anchors to surface coatings, and can be high throughput as a direct photopolymerization reaction. However, the polymer network formation is heterogeneous, evident in distinctive mechanical properties.

By adjusting the kinetics (with comparatively slow base catalysts) of the thiol-Michael addition reaction to prepare oligomeric species, aligned LCEs can be produced via surface anchoring. However, as with LCEs prepared by aza-Michael addition reactions, the oligomerization reaction can occur over hours and limits the throughput of LCE sample preparation.

As indicated above, the present disclosure is directed to the preparation of LCEs via one-step thiol-ene photopolymerization, which addresses the limitations of previous methods of preparing aligned LCEs. This reaction is amenable to surface-enforced alignment, which enables high-fidelity inscription of complex director profiles. The LCE composition can be directly tailored by the concentration of the multifunctional crosslinking monomer(s) (e.g., a tetrathiol, a dithiol); the thermomechanical response of the LCE is tunable through the crosslink density. In a pure thiol-ene step-growth reaction under stoichiometrically equivalent amounts of thiol and enes, the ene monomer, mixed with a thiol chain extender, should result in a linear polymer. The addition of a multifunctional thiol or ene (typically trifunctional or tetrafunctional) monomer, and the concentration of it, is directly related to the crosslink density.

This disclosure describes a direct, one-step thiol-ene photopolymerization reaction process to produce LCE polymer networks with regular and robust architecture. This chemistry is amenable to surface-enforced alignment and high throughput (e.g., samples prepared in <1 minute). The LCE materials exhibit cybotactic nematic phases, which are shown to affect the thermotropic stimuli-response.

The one-step thiol-ene photopolymerization reaction combines an ene or diene monomer with a thiol. In some embodiments, the thiol monomer is a flexible, non-liquid crystalline molecule (e.g., EDDET). In others, a liquid crystalline thiol is used to enhance molecular ordering. Regardless of the thiol structure, photopolymerization in stoichiometric conditions yields alignable LCEs through a unified thiol-ene strategy.

In the following description, reference is made to the accompanying drawing that forms a part hereof and in which is shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

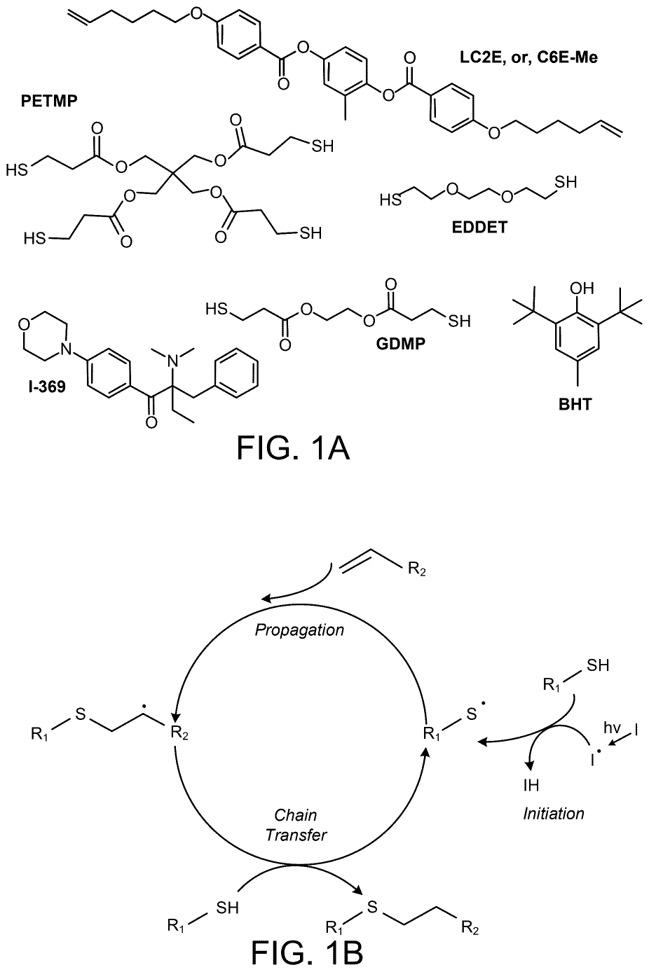

Turning to the figures, FIG. 1A shows various molecules, particularly, a liquid crystal diene monomer 2-methyl-1,4-phenylene bis(4-(hex-5-enyloxy)benzoate) (C6E-Me, also known as LC2E), thiol-functionalized monomers 2,2′-(ethylenedioxy)diethanethiol (EDDET) and ethylene glycol di(3-mercaptopropionate) (GDMP), and pentaerythritol tetrakis(3-mercaptopropionate) (PETMP), which also acts as a crosslinker. FIG. 1A also shows a photoinitiator 2-benzyl-2-dimethylamino-1-(4-morpholinophenyl)-butanone-1 (I-369, which is commercially available as Irgacure 369), and butylated hydroxytoluene, also known as dibutylhydroxytoluene, (BHT), an inhibitor. It is noted that C6E-Me and LC2E are used interchangeably throughout this disclosure.

FIG. 1B outlines a one-step thiol-ene photopolymerization reaction, showing an alkene-functionalized liquid crystal diene monomer copolymerized with a thiol-functionalized monomer. This particular example includes an aliphatic diene, an aliphatic dithiol, and a mercaptopropionate tetrathiol.

Although the specific liquid crystal diene monomer 2-methyl-1,4-phenylene bis(4-(hex-5-enyloxy)benzoate) (C6E-Me or LC2E) is shown in FIGS. 1A and 1B and discussed herein, any suitable liquid crystal diene may be used, such as 2-mnethyl-1,4-phenylene bis(4-(oct-7-enyloxy)benzoate), and those having diene tail systems. The diene monomer may be methylated or unmethylated.

Similarly, although pentaerythritol tetrakis(3-mercaptopropionate) (PETMP) thiol monomer is shown in FIGS. 1A and 1B and discussed herein, any non-liquid crystalline thiol may be used.

Similarly, although 2,2′-(ethylenedioxy)diethanethiol (EDDET) and glycol di(3-mercaptopropionate) (GDMP) thiol monomers are shown, any liquid crystalline or non-liquid crystalline thiol may be used. Additionally, any suitable crosslinker may be used, whether a thiol or not.

Any additives (e.g., inhibitors) and/or initiators (e.g., photoinitiator) may be added. 2-benzyl-2-dimethylamino-1-(4-morpholinophenyl)-butanone-1 (I-369) is one of many common photoinitiators that can be added. An inhibitor, such as butylated hydroxytoluene, also known as dibutylhydroxytoluene, (BHT), can be added to reduce thermal polymerization (e.g., during filling and annealing) to isolate the contribution of ultraviolet (UV) light polymerization.

The relative amounts of the thiol and the ene (including diene) is typically 1:1 thiol:ene stoichiometric ratio of the functional groups, although in some embodiments it may vary from 0.9:1 to 1:0.9 or 0.95:1 to 1:0.95. The concentration of monomers in the composition can range from greater than 50 wt % to 99.9 wt % of the elastomer composition, in some embodiments less than 99 wt %. In some embodiments, the composition consists of only the ene or diene monomer(s), the thiol monomer(s) and an initiator. In some embodiments, one or more of the monomers may also function as a crosslinker, or, a crosslinker may also function as a monomer. An inhibitor may also be present in some embodiments; the use of a small amount of inhibitor results in minimal thermal conversion such that the network formation is primarily induced by photopolymerization.

The copolymerization of the alkene (e.g., a difunctional alkene (diene)) and thiol monomers results in linear polymer chains. Increasing the average functionality of the composition to greater than two by including multifunctional thiol or ene (typically trifunctional or tetrafunctional) monomers results in a crosslinked network. For example, LC2E and EDDET (both difunctional) react to form linear linkages (i.e., increasing the molecular weight between crosslinks) that react with a crosslinker, such as PETMP (tetrafunctional).

Thiol-ene polymerizations are radical-mediated reactions; that is, the photopolymerization can occur merely with a radical initiator. Generally, the execution of the reaction is simple: mix the monomers and initiator (at or close to a 1:1 thiol:ene stoichiometric ratio), and then polymerize the mixture. An ideal reaction has no homopolymerization, no side products, and leads to a high uniform network.

Thiol-ene polymerizations can produce crosslinked polymer networks with widely tunable properties. By adjusting the relative amounts of the thiol monomer to crosslinker (e.g., EDDET to PETMP, or GDMP to PETMP), while maintaining a constant thiol:ene stoichiometric ratio of functional groups, the extent of crosslinking in the LCEs prepared can be adjusted while maintaining constant liquid crystalline content. As an example, the percentage of thiols from EDDET to thiols from the cross linker PETMP can be, e.g., 50:50 to 10:90. Table 1 provides example formulations, where crosslinker concentration was varied by adjusting the relative amounts of thiol functional groups from each monomer.

TABLE 1

| PETMP | Thiols from | Thiols from | |
|---|---|---|---|
| Added | PETMP | EDDET | LC2E Added |
| (mol %) | (%) | (%) | (wt %) |
| 14 | 50 | 50 | 70.2 |
| 18 | 60 | 40 | 69.6 |
| 21 | 70 | 30 | 69.0 |
| 25 | 80 | 20 | 68.5 |
| 29 | 90 | 10 | 67.9 |

As another example, the percentage of thiols from GDMP to the percentage of thiols from the cross linker PETMP can be varied, while maintaining the thiol:ene molar ratio 1:1. To tailor cross-linking, the thiol molar ratios can range from 0:1 PETMP:GDMP to 1:0 PETMP:GDMP, e.g., in increments of 0.1.

By varying the crosslinker amount, the physical properties of the polymerizable composition, the polymerized composition, and the resulting LCE can be tuned, particularly the thermomechanical performance. This is notable, as (1) maximizing liquid crystalline content increases amenability to surface alignment and (2) the liquid crystalline concentration is directly correlated to the magnitude and rate of thermomechanical response. Increasing the crosslinker concentration in the LCEs adjusts the thermomechanical properties of the material. By utilizing step-growth chemistry, the network formation and resulting material properties can be more precisely controlled as the cross-linking mostly occurs through the introduction of multifunctional molecules, rather than solely through homopolymerization.

LCE formulations with approximately even crosslinker:thiol molar ratios (e.g., 0.3-0.6 crosslinker of total) have greater average homopolymerization of the ene groups, e.g., to as much as 29%. Accordingly, while the thiol-ene step-growth reaction is the dominant polymerization mechanism, there is non-negligible contribution of chain growth polymerization of the enes.

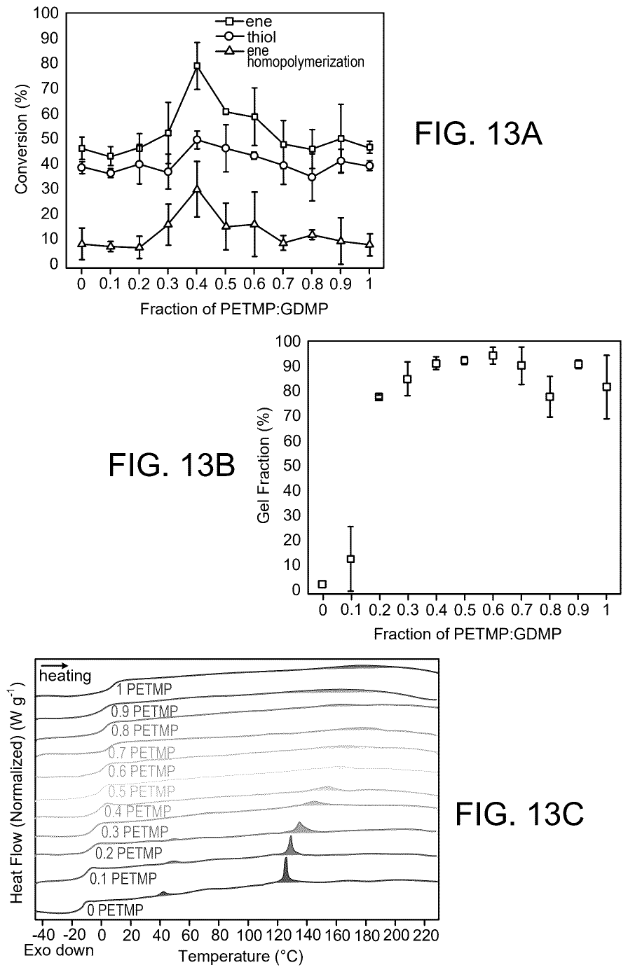

In addition to the homopolymerization of the ene groups, these middle amounts of crosslinker (e.g., 0.3-0.6) also have lower anisotropy values. From this and other trends, there may be a correlation of the moduli anisotropy with the degree of homopolymerization in these LCEs; see, e.g., FIG. 13A.

Increasing the concentration of crosslinker also increases the gel fraction of the material; the gel fraction is shown to partially correspond with the degree of homopolymerization observed with RTIR, as the gel fraction is highest for 0.4-0.6 crosslinker. At higher concentrations of crosslinker, beyond 0.6 crosslinker, the gel fraction begins to decrease along with the conversions. The gel fraction is once again higher for ≥0.9 crosslinker LCEs, despite the large amount of phase separation, due to the high concentration of bulky cross-linking molecules. As phase separation is maximized with 1 crosslinker, the gel fraction becomes much more variable and is lowered, most likely due to inconsistencies within the films. Example gel fractions of exemplary LCEs, at crosslinker increments of 0.1, are shown in FIG. 13B.

Increasing crosslinker concentration in the mixtures generally increases the amount of phase separation. The heterogeneous solution cannot be homogenized with annealing above a 0.8 crosslinker concentration. The phase separation in high concentration crosslinker mixtures is hypothesized to be due to the higher viscosity and bulkiness of the crosslinker, PETMP, resulting in less effective mixing with other monomers within the melt. This effectively leads to regions with different transition temperatures and the coexistence of nematic and isotropic phases, even after annealing at low temperatures, as the bulky crosslinker monomers disrupt the LC phase.

Once the desired phase is observed and well-aligned, with minimal defects, disclination lines, and phase separation, the cell was photopolymerized to form an LCE. The microstructure and alignment, post-polymerization, is consistent with the pre-polymerization orientation and alignment.

Further, the T_{g} and the T_{NI} of the LCE generally increase as a function of crosslinker concentration. The higher cross-linking amount reduces the mobility of polymer chains, which leads to more energy required to induce the glass transition and LC phase transition, thus shifting these temperatures to higher values for the cross-linked LCEs.

Interestingly, the association of T_{NI} and crosslinker concentration is opposite prior to polymerization. This indicates the contribution of the size of crosslinker is likely increasing the average length of mesogen-mesogen interactions prior to polymerization, leading to reduced intermolecular interactions, which shifts the phase transitions to lower temperatures.

FIG. 13C plots representative thermograms of aligned LCEs with increasing crosslinker content. Notably, the peak shape associated with the nematic to isotropic transition for each LCE is starkly influenced by the crosslinker concentration. The sharpest T_{NI} endotherm is evident with 0 crosslinking. This peak is similar in shape and sharpness to a nematic-isotropic transition of a low molar mass liquid crystal and is potentially first-order. As the extent of cross-linking is increased, the sharpness of the transition is reduced, and the breadth of the transition is increased. At near complete crosslinker concentrations, the T_{NI} of the LCE (as evident in the thermograms) is almost identical to the continuous (supercritical) transition observed in LCEs prepared by other polymerization chemistries, particularly those resulting in heterogeneous networks and high degrees of cross-linking. These results indicate that the concentration of cross-linking sites can have a significant impact on the sharpness, and potentially the criticality, of the observed phase transition. A smectic to nematic transition temperature (T_{SN}) is also evident in the representative thermograms for LCEs with more linear character (0-0.2 crosslinker samples) at 42.3° C., 49.6° C., and 49.1° C. for 0, 0.1, and 0.2 crosslinker, respectively.

Thiol-ene photopolymerization offers a straightforward and rapid approach to preparing LCEs amenable to surface alignment; the composition can be adjusted to prepare LCEs with monodomain alignment, which can be done by drawing the liquid crystalline monomer melt into an alignment cell. The material aligns with the rubbing direction of the alignment layers in the nematic phase. Photoinitiation of the monomeric mixture while in the aligned nematic phase forms an LCE that retains monodomain alignment.

The resulting LCEs have low Young's modulus values and soft elastic plateau stresses. The resulting LCEs can be used for many applications, including in or as an adhesive. Because of the surface alignment of the LCEs, the resulting adhesive can have a peel force that is direction dependent. For example, an adhesive article can have easy removal in one direction while having high bonding strength in a different direction. When the LCE is oriented, e.g., as described above and below in the Examples section, the strength of the adhesive to a substrate can be modified to be stronger in one direction than another direction.

The adhesive can be formed by mixing the LCE with another polymer, such as an acrylate, a polyamide, or a polyester. The adhesive is coated or otherwise applied on a substrate such as a polymeric film. In general, such an adhesive is referred to as a pressure sensitive adhesive (PSA). Examples of products that can utilize a direction dependent PSA include tapes (e.g., “painter's tape”) and removable hooks (e.g., products such as Command™ adhesive strips from 3M).

### Experimental

The following non-limiting experimental discussion, examples, and results will further illustrate the polymerization process and the resulting LCEs. Experiments were done with one-step thiol-ene photopolymerization for thiol:diene LCEs using EDDET and for thiol:diene LCEs using GDMP. The same processes for the thiol:diene chemistry can be used with thiol:ene chemistry.

General Methods: The following methods are applicable to both sets of experiments unless indicated.

Alignment cell preparation: Alignment cells were prepared by coating glass substrates (Colorado Concepts) with Elvamide. First, the glass substrates were plasma cleaned for 10 minutes before spin-coating with 0.125 wt % Elvamide in methanol solution. Coated slides were manually rubbed in one direction with a velvet cloth approximately 30 times. Two glass substrates were glued together by the corners using Norland optical adhesive mixed with 30 μm silicon bead spacers or with micro rod spacers. The glass slides with rubbed alignment were placed antiparallel (i.e., the rubbed sides faced each other with opposing directions of rubbing). The adhesive mixture was then cured by exposing the cells to ultraviolet (UV) light for at least 3 min. The glass substrates were slightly offset to provide a “lip” for the LCE melt mixture to be placed upon to enable capillary filling.

LCEs with director profiles described by +1 azimuthal defects were prepared from patterned photoalignment cells. Again, glass substrates were first plasma cleaned for 10 minutes. Subsequently, substrates were spin-coated with 0.33 wt % PAAD 22 in dimethyl formamide solution at 2000 rpm for 1 minute. Coated substrates were placed on a hot plate at 100° C. for 30 minutes to remove residual solvent. The cell assembly was subsequently completed following the steps outlined above. After assembly, the photoalignment cells were exposed to 445 nm light projected through a diffractive waveplate (Beam Co.).

Real Time Infrared Spectroscopy: Real-time infrared spectroscopy (RTIR) was conducted using a custom-built heating stage and a Nicolet iS50 FTIR spectrometer to examine the reaction kinetics of functional group conversion during the reaction. Mixtures were melted and placed between salt plates on a hot plate at 100° C. The salt plates were moved to the RTIR stage, where the temperature was decreased to 35° C. The values for the area under the thiol peak (2550-2600 cm⁻¹) and alkene peak (~1640 cm⁻¹) were recorded approximately every half second. Samples were polymerized for 5 minutes with 365 nm light. Conversion of functional groups was calculated via Equation 1:

$$X = \frac{{A}_{i} - {A}_{f}}{{A}_{i}} \qquad ( 1 )$$

where X is the conversion, Aᵢ is the area under the peak before polymerization, and A_{f} is the area under the peak at a given time point after initiating polymerization. These conversions were compared to the theoretical conversion at gelation for a step-growth reaction by Equation 2:

$${p}_{c} = {[ r ( {f}_{a v g , e n e} - 1 ) ( {f}_{a v g , thiol} - 1 ) ]}^{- 0.5} \qquad ( 2 )$$

where p_{c} is the conversion at gelation, r is the stoichiometric balance of functional groups (in this case, r=1), f_{avg,ene} is the weighted average functionality of alkene functionalized monomers, and f_{avg,thiol} is the weighted average functionality of thiol functionalized monomers in the system.

Gel Fractions: Gel fractions of LCEs were taken to confirm network formation. Samples were weighed initially before soaking in DCM for at least 24 hours, in some experiments 72 hours. Samples were then dried for at least 3 hours, in some experiments 24 hours, on a hot plate set to 45° C. before weighing again. Gel fractions were calculated according to Equation 3:

$${f}_{gel} = \frac{{m}_{f}}{{m}_{i}} \qquad ( 3 )$$

where f_{gel} is the gel fraction, m_{f} is the final measured mass after soaking in DCM and drying for 24 hours, and mᵢ is the initial measured mass before soaking in DCM. Some reported gel fractions were averaged from at least a minimum of three replicates for each formulation.

Polarized Optical Microscopy: LCE alignment was assessed with polarized optical microscopy (POM) using a Nikon Eclipse Ci-Pol with 10× and 20× optical objectives pre-anneal, post-anneal, and post-polymerization. LCEs were observed at 0°, 45°, and 90° rotation between crossed polarizers. The thermotropic transitions of some of the mixtures were assessed on cooling after the mixtures were drawn into alignment cells. Each sample was heated above the isotropic transition and then controllably cooled via a temperature control stage (Instec, MK2000 temperature control system) equipped with liquid nitrogen regulation.

X-Ray Scattering: The alignment and phase behavior of the LCEs was quantified with wide-angle X-ray scattering (WAXS) and small-angle X-ray scattering (SAXS) via a Xenocs Xeuss 3.0 SAXS/WAXS operating in vacuum and transmission using an 8 keV rotating copper anode. The SAXS sample to detector distance was 0.37 m and the WAXS sample to detector distance was 0.043 m. For some experiments, the samples were exposed for 180 seconds for WAXS scans and 720 seconds for SAXS scans. For other experiments, SAXS and WAXS patterns were collected using 600 s exposures in vacuum. Geometry corrections were made using lanthanum hexaboride (WAXS) and silver behenate (SAXS) standards.

Hermans orientation parameter was calculated by Equations 4 and 5:

$$S = \frac{1}{2} ( 3 〈 {cos}^{2} θ 〉 - 1 ) \qquad ( 4 )$$

$$〈 {cos}^{2} θ 〉 = \frac{{\int }_{0}^{π / 2} I ( θ ) sin θ {cos}^{2} θ d θ}{{\int }_{0}^{π / 2} I ( θ ) sin θ d θ} \qquad ( 5 )$$

where S is Hermans orientation parameter, θ is the azimuthal angle, and I(θ) is the azimuthal intensity distribution.

Equation 5 gives the average angle of liquid crystalline mesogens to the nematic director. Cybotactic nematic phase parameters, including smectic C layer spacing, tilt angle, and cell length, were calculated from SAXS patterns using Equations 6, 7, and 8:

$$d = \frac{2 π}{{q}_{S A X S}} \qquad ( 6 )$$

$$β = \frac{{θ}_{{2}^{-}} {θ}_{1}}{2} \qquad ( 7 )$$

$$L = \frac{d}{cos β} \qquad ( 8 )$$

where d is the smectic C layer spacing, qs_{AXS} is the q value at which the maximum intensity occurs in the small-angle region of interest, β is the tilt angle of smectic C layers to the nematic director, θ₁ and θ₂ are the angles of maximum intensity for the pair of diffuse arcs in the cybotactic SAXS pattern, and L is the cell length of smectic layers.

Differential Scanning Calorimetry: Differential scanning calorimetry (DSC) was conducted using TA Instruments' DSC 2500 to determine the thermal properties of LCEs. A heat-cool-heat cycle was applied to samples at a heating and cooling rate of 5° C./min. Glass transition temperatures were obtained by the midpoint of the step change in the baseline on the second heating curve. The temperature at which the local maximum of the peak occurs on the second heating curve identified nematic-to-isotropic transition temperatures.

Tensile Testing: Mechanical properties of some of the LCEs were measured with TA Instruments' DMA 850 dynamic mechanical analyzer. Tensile testing was performed on monodomain samples with strips cut perpendicular and parallel to the nematic director. Samples were tested in rectangular strips with dimensions of approximately 2 mm width and 6 mm length. Tensile tests were performed to failure at room temperature with a linear strain rate of 5%/min of the original sample length. Young's modulus values were taken from the linear region of the tensile curve at low strain values (1-3%). Modulus contrast was calculated as the ratio between Young's modulus parallel and perpendicular to the alignment direction.

Thermomechanical Response: Thermomechanical testing was performed on monodomain samples using the DMA 850 and tension clamps. LCE specimens were cut into rectangular strips with the long axis parallel to the direction of alignment. The width was approximately 2 mm, and the sample was loaded with a gap of ~10 mm, oriented such that the alignment was normal to the clamps. The stress on the sample was maintained at approximately 0 MPa, and the contractile strain was tracked as the sample was ramped, in some experiments from room temperature to 220° C. at a rate of 5° C./min, and in other experiments from room temperature to 230° C., cooled back to 10° C., and again heated to 230° C. at 5° C./min. For some experiments, a minimum of three tests were performed for each formulation; data reported is the average and standard deviation of these measurements from the second heating for the strain response as a function of temperature and the corresponding first derivative.

### Thiol—Diene LCEs

All LCEs in this section were prepared from compositions utilizing a 1:1 functional group ratio of thiol:ene. The starting materials used were photoinitiator 2-benzyl-2-dimethylamino-1-(4-morpholinophenyl)-butanone-1 (IRGACURE-369 (I-369), IGM Resins), thiol monomers 2,2′-(ethylenedioxy)diethanethiol (EDDET, Sigma-Aldrich) and pentaerythritol tetrakis(3-mercaptopropionate) (PETMP, Sigma-Aldrich), and liquid crystalline “ene” monomer 2-methyl-1,4-phenylene bis(4-(hex-5-enyloxy)benzoate) (LC2E, SYNTHON Chemicals GmbH & Co. KG).

The thiol-diene LCEs were prepared by the one-step thiol-ene photopolymerization of the liquid crystal monomer LC2E and thiol monomers PETMP and EDDET, which are shown in FIG. 1A using the ingredients in the amounts listed in Table 1.

The amount of crosslinker incorporated was adjusted by the ratio of PETMP:EDDET in the mixture. The mixture of I-369 and LC2E was melt-mixed at 180° C. The mixture was set on a hot plate at 100° C. with the alignment cell for 10 minutes. PETMP and EDDET were added, and the mixture was vortexed for 5 minutes. The mixture was filled at 100° C. in its isotropic state into the alignment cell via capillary action by depositing the mixture to the overhang of the cell via pipette. After the cell was filled, it was transferred to another hot plate set to 35° C., in the mixture's nematic state, for 30 minutes, after which the cell was exposed to 365 nm light at 3 mW cm⁻² for 5 minutes to complete polymerization. The cell was soaked in water for 24 hours and opened with a razor blade to release the LCE.

As the concentration of EDDET and PETMP was commensurately adjusted, the crosslinker content increased from approximately 14 mol % to 29 mol %. The relative mass fraction (reported here as wt % in Table 1) of liquid crystal monomer changed very little between formulations (from 67 wt % to 70 wt %). As a result, the phase behavior of these compositions was similar and allowed materials to be prepared at identical conditions (35° C.) in the nematic phase.

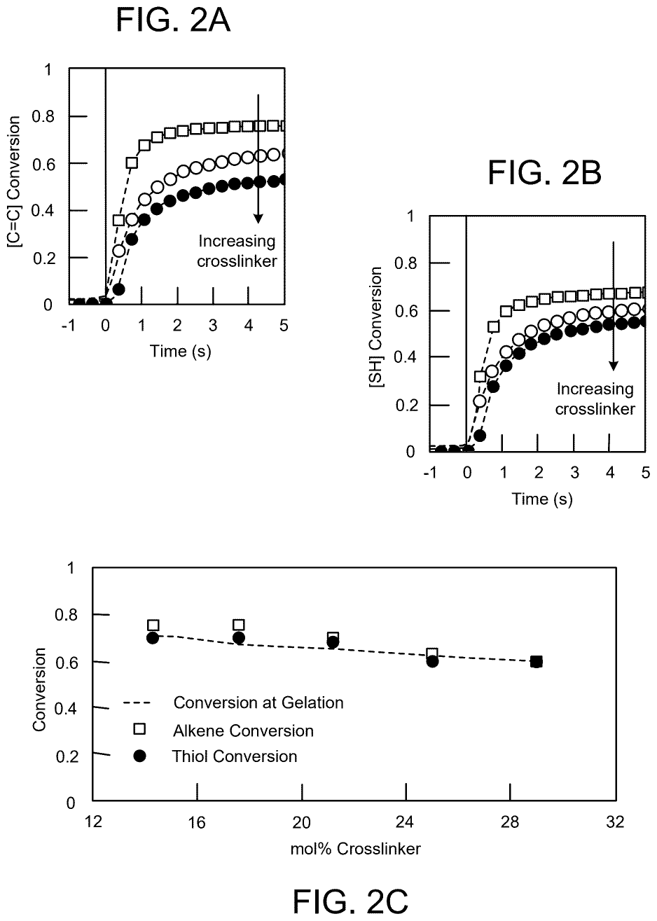

The conversion of thiol and alkene functional groups was monitored with RTIR during photopolymerization. FIGS. 2A and 2B show alkene (FIG. 2A) and thiol functional group (FIG. 2B) conversion during the initial 5 seconds of photopolymerization for three LCE compositions prepared with 14 mol % PETMP (squares), 21 mol % PETMP (hollow circles), and 29 mol % PETMP (filled black circles). FIG. 2C shows the overall functional group conversion maps to the calculated gel point conversion.

Comparing the slope of conversion-time data in the linear region of FIGS. 2A and 2B indicates that the reaction rate decreased with more crosslinker addition. Comparatively, LCEs prepared with lower crosslinker concentration had slightly more conversion of alkene functional groups than thiol functional groups. This potentially indicates a minor extent of homopolymerization of LC2E. However, the polymer network is formed by thiol-ene bonds via step-growth polymerization. While the overall conversion is low, the measured gel fractions are high (i.e., greater than 90% in all cases, as shown in Table 2).

TABLE 2

| PETMP Added | Gel Fraction |
|---|---|
| (mol %) | (%) |
| 14 | 93.6 ± 0.4 |
| 18 | 91.9 ± 0.9 |
| 21 | 93.4 ± 0.6 |
| 25 | 94.4 ± 0.3 |
| 29 | 95.2 ± 0.4 |

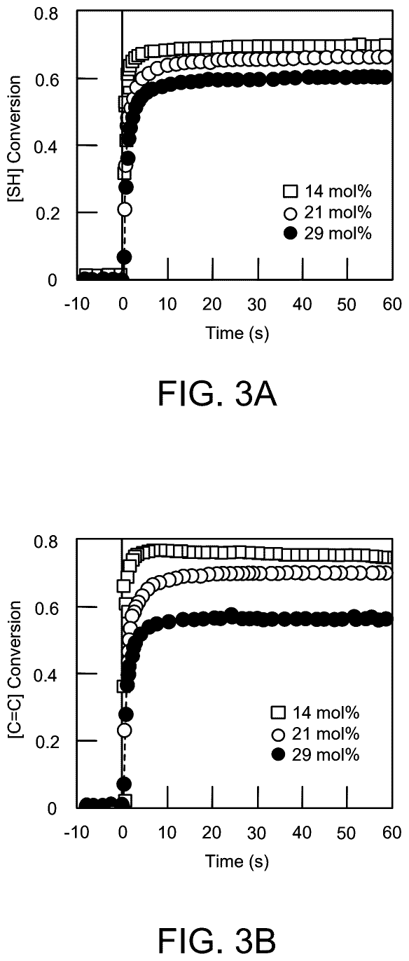

The conversion of both thiol and ene functional groups can be affected by crosslinker concentration and the associated influence on gel point conversion; Equation 2 was used to predict the conversion at gelation. As evident in FIG. 2C, the experimentally measured conversions closely match the calculated gel point conversions. From these data, the thiol-ene reaction is generally conventional and proceeded rapidly on initiation, requiring less than 1 minute of photopolymerization to reach near the maximal conversion of functional groups (see FIGS. 3A and 3B, where 14 mol % PETMP (squares), 21 mol % PETMP (hollow circles), and 29 mol % PETMP (filled black circles)).

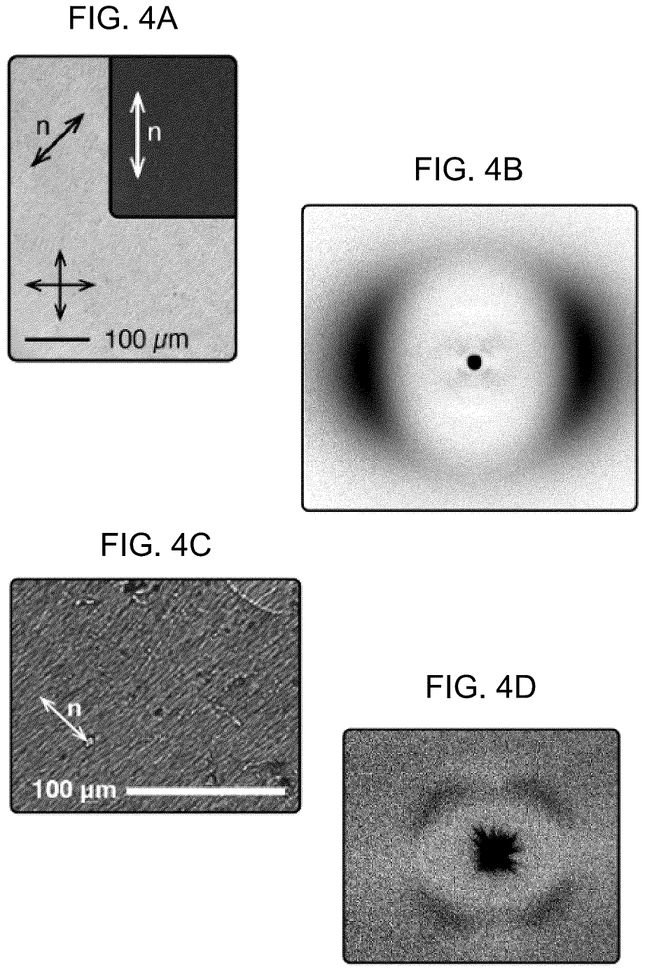

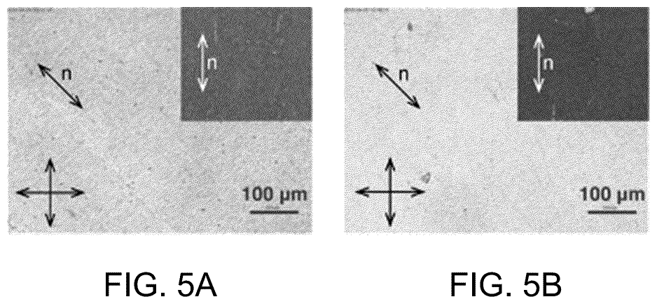

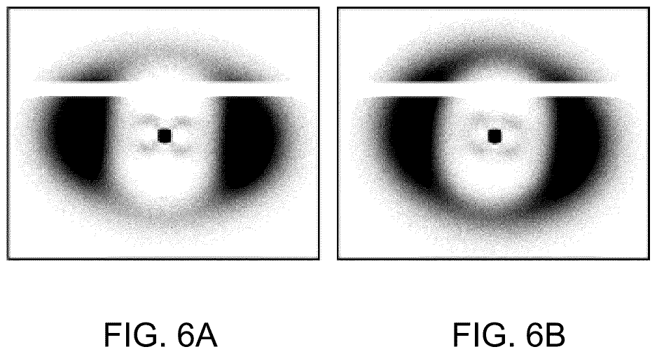

The monodomain alignment was assessed via polarized optical microscopy (POM) and is shown in FIG. 4A, where the birefringence of monodomain LCEs is illustrated for a representative sample with 14 mol % PETMP; see also FIG. 5A and FIG. 5B for other samples. The alignment was also quantified with X-ray scattering at wide angles (WAXS) for LCEs prepared with 14 mol %, 21 mol %, and 29 mol % PETMP. FIG. 4B shows a representative scattering pattern of LCEs prepared with 14 mol % PETMP; see FIG. 6A and FIG. 6B for other samples). The characteristic nematic eyebrow evident in FIG. 4B confirms alignment. The orientation parameter was calculated from the azimuthal intensity profile (via Equations 4 and 5) and ranges from 0.51 to 0.56 (see Table 3). These values confirm strong nematic alignment similar to values reported in other LCEs prepared by surface alignment.

TABLE 3

| PETMP Added | Orientation | Layer Spacing | Tilt Angle | Cell Length |
|---|---|---|---|---|
| (mol %) | Parameter | (Å) | (°) | (Å) |
| 14 | 0.52 | 29.5 | 42.8 | 40.2 |
| 21 | 0.54 | 29.9 | 45.3 | 42.5 |
| 29 | 0.56 | 30.4 | 45.3 | 43.2 |

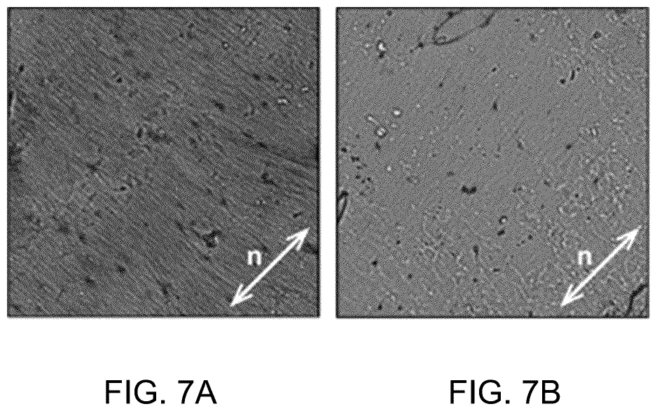

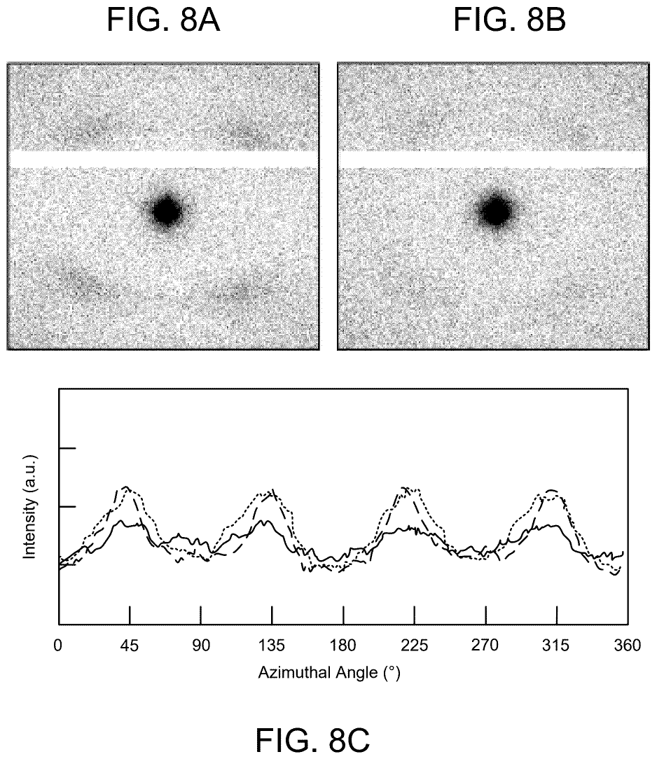

Microstructure is evident in the polarized micrographs with regular striation normal to the direction of alignment (see FIG. 4C and FIGS. 7A-7B). Further, the wide-angle X-ray scattering (WAXS) pattern in FIG. 4B contains multiple faint, diffuse arcs at smaller angles, indicating additional liquid crystalline ordering. To elucidate the phase retention of these LCEs, small-angle X-ray scattering (SAXS) patterns were evaluated; FIG. 4D shows the SAXS pattern of a representative sample with 14 mol % PETMP (see FIGS. 8A-8C for other samples). Four diffuse rod-shaped scattering arcs are present, with the top and bottom pairs overlapping a faint nematic scattering arc at constant q oriented along the alignment direction and coincident to the length of the liquid crystalline mesogen. This scattering pattern is associated with the cybotactic nematic phase, in which a nematic phase has regions of short-range smectic order. In these domains, the liquid crystalline mesogens maintain orientational ordering along the director but tilted smectic C-like phases form. The angle between the director and the layer normal is referred to as the “tilt angle” and the thickness of the layers as the “cell length”, which is usually on the order of magnitude of the extended liquid crystalline component. The cybotactic nematic phase has been retained in liquid crystal polymer materials, including LCEs. The average smectic C domain layer spacing, the tilt angle, and the cell length are given for samples with three different concentrations of PETMP in Table 3. The cell lengths are on the order of the extended liquid crystalline unit length (which is approximately 36.7 Å).

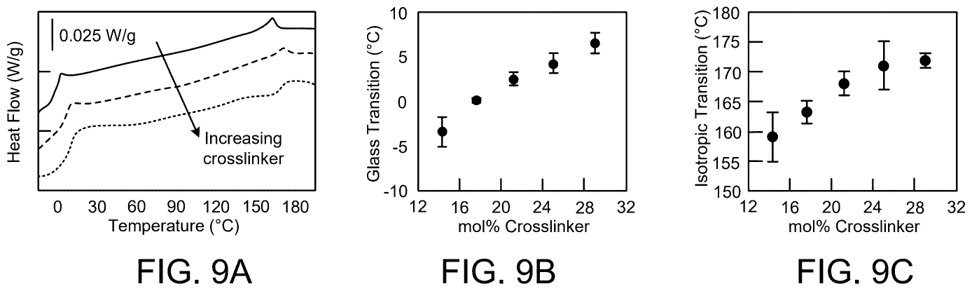

Increasing the crosslinker concentration in the LCEs adjusts the thermomechanical properties. DSC measurements of the LCEs confirm that increasing the crosslinker concentration increases the glass transition temperature (FIGS. 9A and 9B). The glass transition temperatures for the LCEs examined are below room temperature. At higher temperatures, the LCEs exhibit a nematic-isotropic transition. Increasing the crosslinker concentration increases the nematic-isotropic transition temperature of the LCE (FIG. 9C).

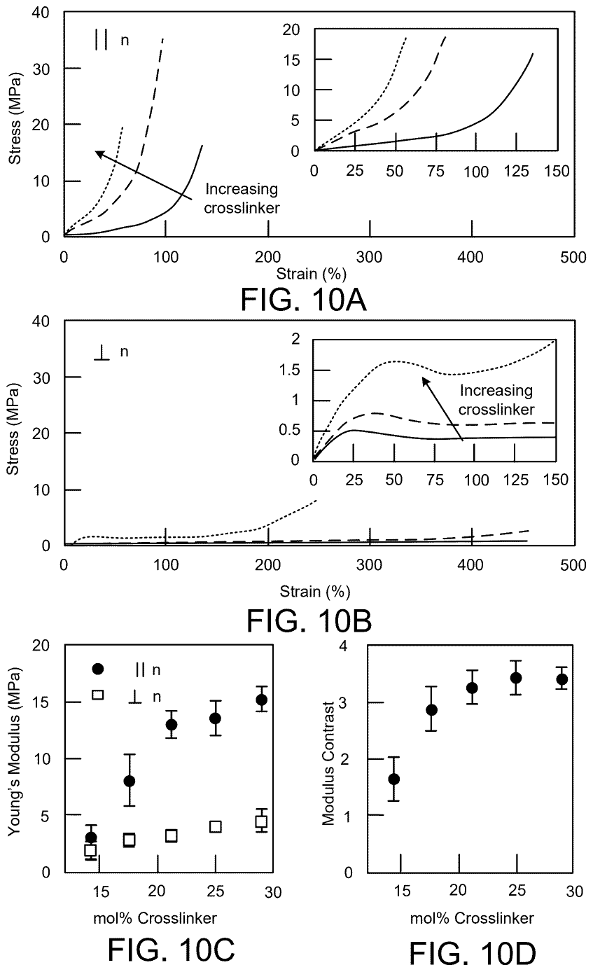

The mechanical properties of the LCEs were examined with tensile testing parallel and perpendicular to the nematic director. When the LCEs were deformed parallel to the alignment direction, the stress-strain response is classical (FIG. 10A). Notably, increasing crosslinker concentration sharpens strain hardening. The stress-strain response of the LCEs was nonlinear when deformed perpendicular to the alignment direction, also referred to as soft elasticity. Increasing crosslinker concentration sharpens strain hardening and shifts this region to lower strain values. The stress threshold to induce soft elasticity and the extent of the soft elastic plateau also increased with increasing crosslinker concentration.

Young's moduli were measured in the linear regime in both directions to illustrate the influence of crosslinker concentration on the mechanical properties of the LCEs (summarized in FIG. 10C). Increasing the crosslink density increased the Young's moduli in both axes. To assess the influence of crosslinker concentration on the mechanical properties of the LCE, the modulus contrast (Y_{∥}/Y_{⊥}) was calculated and shown in FIG. 10D. As evident in FIG. 10D, increasing the crosslinker concentration increased the modulus contrast.

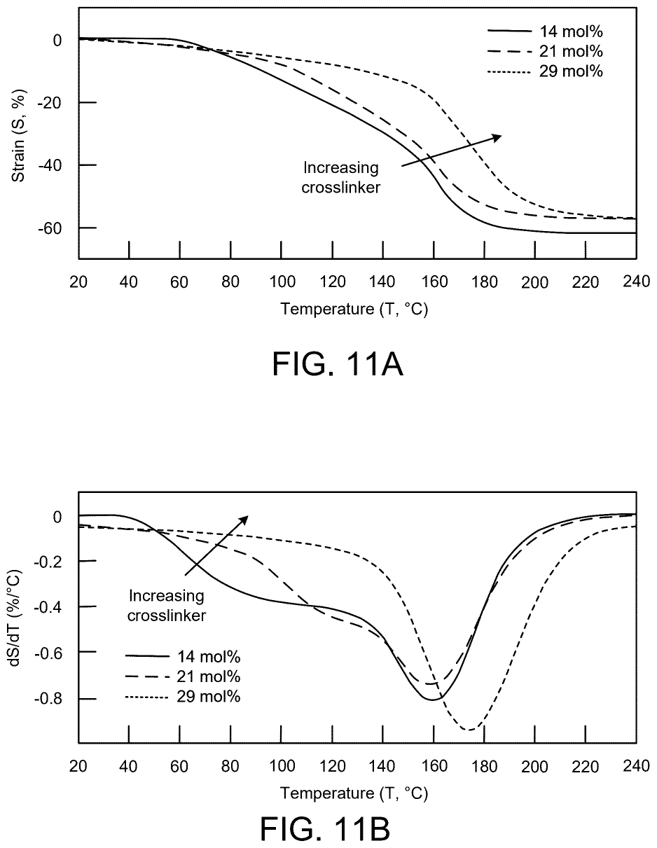

The thermotropic stimuli response of LCEs parallel to the alignment direction was examined. Monodomain LCEs were heated from room temperature beyond the nematic-isotropic transition peak observed via DSC (FIG. 9). The contractile strain was measured in tension along the aligned direction (FIG. 11A) as a function of temperature for three LCEs prepared with 14 mol %, 21 mol %, and 29 mol % PETMP. The 14 mol % is represented by the solid line, the 21 mol % is represented by the large dashed line, and the 29 mol % is represented by the small dashed line. FIG. 11B shows the corresponding derivative for the LCEs, again where 14 mol % is represented by the solid line, the 21 mol % is represented by the large dashed line, and the 29 mol % PETMP is represented by the small dashed line.

As more crosslinker was incorporated into the system, the contractile strain response shifted to higher temperatures. Notably, increasing crosslinker concentration did not affect the magnitude of the achievable strain. Close examination of the thermomechanical curve shape of the LCEs prepared with 14 mol % and 21 mol % PETMP revealed that the response has two separate slopes. This is best visualized by taking the derivative of the strain-temperature curves (FIG. 11B). As crosslinker content was decreased, the lower temperature response became broader and started at lower temperatures. Interestingly, this initial transition did not appear in the DSC thermograms. The second response region aligns with the nematic-isotropic transition temperature determined by DSC.

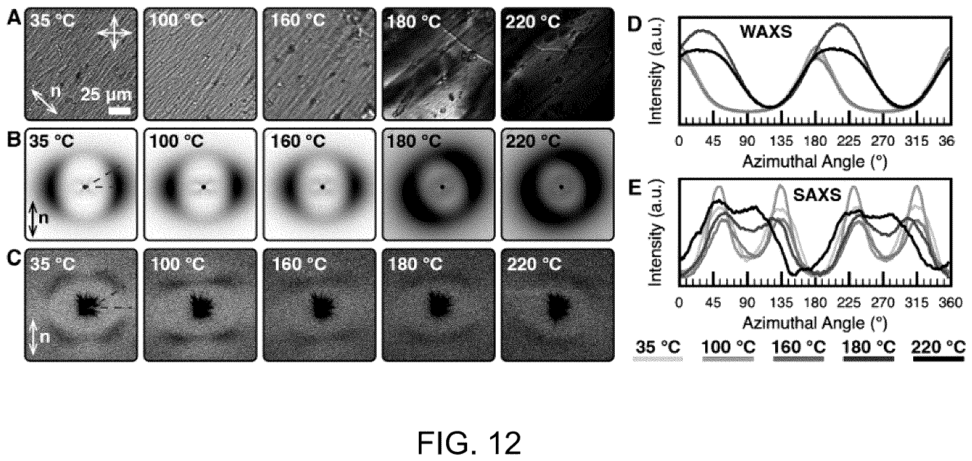

POM, SAXS, and WAXS experiments were performed on LCEs prepared with 14 mol % PETMP heated through the nematic-isotropic transition temperature; the results are in FIGS. 7A through 7E. The POM micrographs in FIG. 12A show that the LCE maintained birefringence through the first transition (up to 160° C.) before losing almost all birefringence during the second transition (up to 220° C.). This is consistent with the nematic-isotropic transition observed via DSC in FIG. 9. The WAXS profiles in FIG. 12B confirmed that the LCE remained aligned through the first transition before losing alignment during the second transition. The SAXS profiles in FIG. 12C indicate that the initial stimuli-response may be associated with the cybotactic nematic phase. As with the evolution of the nematic phase, the small angle peaks associated with the cybotactic nematic phase become fainter in the second transition. Data presented in FIG. 12D and FIG. 12E show the corresponding intensity profiles as a function of azimuthal angle (designated by the red dashed lines in the first image of FIG. 12B and FIG. 12C) in the wide-angle and small-angle regions, respectively. From 35° C. to 100° C., both intensity profiles become sharper, indicating improved alignment of the cybotactic nematic phase. On increasing the temperature to 160° C., the sharpness decreased and is nearly lost at 220° C. during the second transition, though residual alignment remains with possible director rotation.

POM, WAXS, and SAXS were also done for samples heated discretely from room temperature to 220° C. Samples were heated with an INSTEC thermal stage for POM experiments. SAXS and WAXS profiles were obtained using the Xenocs Xeuss 3.0 SAXS/WAXS equipped with a Linkam thermal stage.

The deformation of LCEs with +1 azimuthal defect alignment in 3 dimensions was characterized via a Keyence VR-3200 wide-area 3-D measurement system. Height maps were produced to characterize the LCEs' shape profile and quantify the amount of deformation.

### Thiol—Ene LCEs

Thiol:ene LCEs were prepared generally as described above, using a 1:1 functional group ratio of thiol:ene. The starting materials used were liquid crystalline “ene” monomer 2-methyl-1,4-phenylene bis(4-(hex-5-enyloxy)benzoate) (C6E-Me, SYNTHON Chemicals GmbH & Co. KG), ethylene glycol bis(3-mercaoptopropionate (GDMP, TCI), PETMP (Sigma-Aldrich), I-369 (IGM Resins), and 2,6-di-tert-butyl-4-methylphonel (BHT, Sigma-Aldrich).

Prior to use, the C6E-Me was purified via a 50 g silica cartridge in a Biotage Isolaera automate column with a hexanes to ethyl acetate grade of 0-50%. The stock C6E-Me monomer underwent purification processes more than once to create different columned monomer batches. This resulted in some minor variability in LCE properties when using different purified batches.

C6E-Me, 1.5 wt % I-369, and 0.25 wt % BHT were mixed in a vial. These solids were melted at 171° C. and then mixed for 1 min with a vortexer. After mixing, dithiol (GDMP) and tetrathiol (PETMP) monomers (both liquids) were added. To tailor cross-linking, the LCEs were prepared with thiol molar ratios spanning from 0:1 PETMP:GDMP to 1:0 PETMP:GDMP in increments of 0.1. After the addition of thiol monomer(s), the mixtures were heated to 127° C. for 2 min, mixed, and then drawn from the vial and placed on the lip of the alignment cell to fill the cell via capillary action. The cell was heated to temperatures at least 10° C. above the observed nematic to isotropic transition temperature (T_{NI}) of the melt mixture. The T_{NI} of the mixture was precisely determined with differential scanning calorimetry (DSC). After filling, the sample was cooled below the T_{NI} with a temperature control stage (Instec, MK2000 temperature control system). The alignment of the samples before polymerization was assessed with a polarized optical microscope (POM). Any defects caused by disclination lines and initial phase separation, which was apparent during the processing, were annihilated via annealing at reduced temperatures. Once the samples exhibited no change in alignment and had minimal defects, LCEs were photopolymerized with a 365 nm UV light at ~6 mW cm⁻² for 10 min. After polymerization, the LCE film was removed from the confines of the alignment cell by soaking the cell in deionized (DI) water at 80° C. Soaking the alignment cell in DI water considerably assists with the separation of the cell by wedging a razor blade between the glass substrates.

The thermotropic phase behavior of the monomers, formulations, and LCE polymer networks was determined via DSC generally as described above. Specifically, these measurements were taken from samples of 2-5 mg of material that were hermetically sealed in aluminum pans. Monomers were heated from −10 to 200° C., cooled to −50° C., and heated to 200° C. at 10° C./min. Formulations were heated from −50 to 150° C., cooled to −50° C., and heated to 150° C. at 10° C./min. LCE polymer networks were heated from −50 to 200° C., cooled to −50° C., and heated to 230° C. at 10° C./min. At least three replicates were completed for each prepolymer and LCE formulation with representative thermograms graphed and the average phase transition temperatures reported with the standard deviations.

Mechanical properties were measured of these LCEs with a TA Instruments RSA-G2 Dynamic Solids Analyzer with samples loaded using an aspect ratio of 1:4 width:length, where the length correlated to the loading gap. LCEs were secured to the testing clamps with Kapton tape. Tensile tests were conducted at room temperature until failure at a linear strain rate of 5% min⁻¹ of the loading gap length. Data is reported as an average of at least three replicates for each LCE formulation subject to deformation parallel or perpendicular to the alignment director.

For these LCEs, a Nicolet iS50 infrared spectrometer was adapted to enable real-time infrared spectroscopy (RTIR) to examine the photopolymerization kinetics. Concurrent to LCE sample preparation, the samples were tested via RTIR with a small amount of each formulation placed between two NaCl substrates and subjected to the identical thermal history as the “conventional” cell. The NaCl plates were transferred to the RTIR heating stage, which was set to the annealing temperature below the T_{NI} of each formulation. Spectra were collected at 0.75 s intervals at a resolution of 16 cm⁻¹ from 4,000 to 400 cm⁻¹. The KBr beam splitter was set to a gain of 1, optical velocity of 0.4747, and aperture of 100. Both the alignment cell and NaCl cells were concurrently exposed to UV light for 10 min using 365 nm UV light at ~6 mW cm⁻² to ensure equivalent and parallel assessment of conversion of the thiol and alkene functional groups. Kinetic analysis utilized the thiol peak at 2573 cm⁻¹ and alkene peak at 1640 cm⁻¹. The kinetic analysis used the peak height values from the spectra at 0 and 10 min of UV exposure. These results were verified through the deconvolution of overlapping peaks using OriginPro to then calculate the conversion based on the peak areas.

Monomer conversion was calculated using Equation (1), above. At least three replicates were completed for each formulation to report an average conversion based on the peak areas. The overall functional groups conversion, as a function of crosslinker:thiol monomer, is shown in FIG. 13A.

Gel fractions for the samples are shown in FIG. 13B.

DCS thermograms of the LCE samples, as a function of the molar ratio of crosslinker to thiol monomer, are shown in FIG. 13C.

The Hermans orientation parameter of the LCE was calculated using Equations (4) and (5), above. A background subtraction for the orientation parameter calculations was completed with a zero-baseline offset method. The orientation parameter was calculated from WAXS patterns using a custom MATLAB script. The coherence length was estimated from both WAXS and SAXS using the Scherrer equation, shown as Equation 9.

$$τ = \frac{K λ}{β cos θ} \qquad ( 9 )$$

where τ is the mean size of the ordered (crystalline) domains, which may be smaller or equal to the grain size, K is a dimensionless shape factor, λ is the X-ray wavelength, β is the line broadening at half the maximum intensity (FWHM), after subtracting the instrumental line broadening, in radians, and 0 is the Bragg angle.

A Gaussian line shape was used to fit the peak and a value of 1 was used for K to simplify comparisons. The Nika software package in Igor Pro was used to reduce two-dimensional (2-D) to one-dimensional (1-D) data for each pattern while OriginPro was used to perform the Gaussian peak fitting. At least three tests with SAXS and WAXS were performed for each formulation. The reported data is the average and standard deviation of these measurements for the coherence lengths and orientation parameters.

The material compositions described herein are amenable to complex shapes and patterns. Upon heating, the LCEs can transform from physically flat to three dimensional (3-D), e.g., a cone shape or a slight saddle-like shape.

Thus, described here is a direct, one-step thiol-ene photopolymerization strategy for producing aligned liquid crystal elastomers (LCEs) with tunable thermomechanical performance. The reaction leverages stoichiometrically balanced mixtures of thiol and ene monomers—including both liquid crystalline and non-liquid crystalline thiols—together with multifunctional crosslinkers. This chemistry enables surface-aligned LCEs with monodomain ordering and programmable response. Two general system embodiments are described: (1) a thiol-diene system using flexible non-liquid crystalline thiols, and (2) a thiol-ene system using liquid crystalline thiols. Both systems exhibit fast polymerization kinetics, high gel fractions, and thermomechanical behavior sensitive to crosslinker concentration, thus offering a modular platform for aligned LCE fabrication.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended. Various features and details have been provided in the multiple compositions described above. It is to be understood that any features or details of one compositions may be utilized for any other compositions, unless contrary to the construction or configuration. Any variations may be made.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

What is claimed is:

1. A liquid crystal elastomer (LCE) composition composed of a liquid crystal ene monomer(s), a thiol monomer(s), a crosslinker comprising one or more of a multifunctional thiol and multifunctional ene monomer(s), and an initiator.

2. The LCE composition of claim 1, wherein the thiol monomer(s) are non-liquid crystalline thiol monomer(s).

3. The LCE composition of claim 1, wherein the thiol monomer(s) are liquid crystalline thiol monomer(s).

4. The LCE composition of claim 1 having a 1:1 stoichiometric ratio of thiol:ene functional groups.

5. The LCE composition of claim 1, wherein the crosslinker is a trifunctional or tetrafunctional monomer.

6. The LCE composition of claim 1, wherein the initiator is a photoinitiator.

7. The LCE composition of claim 1, wherein:
the liquid crystal diene monomer(s) comprises an aliphatic diene,
the thiol monomer(s) comprises an aliphatic dithiol and a tetrathiol.

8. The LCE composition of claim 1 further comprising a radical inhibitor.

9. The LCE composition of claim 1 incorporated into a product as an adhesive.

10. A liquid crystal elastomer (LCE) composition comprising a diene monomer(s), 2,2′-(ethylenedioxy)diethanethiol (EDDET) thiol monomer, a thiol crosslinker, and an initiator.

11. The LCE composition of claim 10 wherein the thiol crosslinker is pentaerythritol tetrakis(3-mercaptopropionate) (PETMP).

12. The LCE composition of claim 11 wherein the diene monomer is 2-methyl-1,4-phenylene bis(4-(hex-5-enyloxy)benzoate).

13. A liquid crystal elastomer (LCE) composition comprising a diene monomer(s), ethylene glycol di(3-mercaptopropionate) (GDMP) thiol monomer, a thiol crosslinker, an initiator, and a radical inhibitor.

14. The LCE composition of claim 13 wherein the thiol crosslinker is pentaerythritol tetrakis(3-mercaptopropionate) (PETMP).

15. The LCE composition of claim 14 wherein the diene monomer is 2-methyl-1,4-phenylene bis(4-(hex-5-enyloxy)benzoate).
